(19) United States
(12) Patent Application Publication
(10) Pub. No.: US 2014/0326769 A1
(43) Pub. Date: Nov. 6, 2014

(54) Adaptive Carrier Assemblies and Systems for the Transport of Loads on a Vehicle

(71) Applicant: John Alfred Hinchey, Manchester, NH (US)

(72) Inventor: John Alfred Hinchey, Manchester, NH (US)

(21) Appl. No.: 14/267,788

(22) Filed: May 1, 2014

Related U.S. Application Data
(60) Provisional application No. 61/854,829, filed on May 3, 2013.

(51) Int. Cl. B60R 11/00

(52) U.S. Cl. CPC B60R 11/00; B60R 2011/0042
USPC 224/562

(57) ABSTRACT

Disclosed herein are apparatuses and systems for transporting loads on a vehicle such as a car. The disclosed apparatuses and systems allow for secure and efficient transportation of loads, such as recreational equipment. In particular embodiments, an apparatus (also herein referred to as an Adaptive Carrier) comprises at least one Adaptive Carrier Assembly that can comprise a base and Distributed Magnet Assemblies. The Adaptive Carrier Assembly can be manifested in variety of configurations and is typically a compact size for improved gas efficiency.

### FIELD OF THE INVENTION

The apparatus disclosed herein relates to motor vehicle accessories. In particular, the apparatus disclosed herein relates to assemblies for securing material to a location on a motor vehicle such as a roof, trunk, hatch, and other body portion of the motor vehicle.

### BACKGROUND OF THE INVENTION

Some motor vehicles do not have any roof, trunk, hatch or body racks offered by the manufacturer. Commercially available options are available but generally involve clamping to the water run-off side rails of the roof, which has the potential to damage them. An alternative is a carrier secured with magnets. However, available magnetic carriers do not work well with many vehicle models because available magnetic carriers only work on vehicles with smooth tops and no sun roof. This is due to such car models having multiple grooves on the roof running front to back, which does not allow the magnetic carrier to secure firmly to the roof and many are designed to function only on vehicle roofs. In short, available magnetic carriers will not work safely for a large population of vehicles.

Furthermore, commercially-available roof rack assemblies also have other problems including generally having large profiles. A large profile roof rack increase drag, thereby decreasing the handling and fuel efficiency of the automobile.

Therefore, there remains a need for a rack assembly that allows for the safe and secure transportation of equipment on all steel roofs, including both smooth and grooved steel roofs. In addition, there remains a need for a roof rack assembly that reduces the potential for drag as compared to known roof racks. Furthermore, some operators prefer a carrier which can function off roof i.e. one which can be attached to the vehicle body, trunk, or hatch.

### SUMMARY OF THE INVENTION

The disclosed assemblies solve the aforementioned problems and enable additional carrier options. The disclosed assemblies allow for secure transportation of equipment, such as recreational equipment including skis, snowboards, and bikes, on all ferrous roof, trunk, hatch, or other body surface, smooth or irregular, with or without sun roofs. Additionally, the disclosed rack assemblies have a reduced profile compared to commercially available roof racks, significantly improving appearance, increasing fuel economy, and can safely and effectively function on vehicle trunks, hatches, sides and front and back ferrous surfaces—of any contour—as well as ferrous roofs. The disclosed assemblies further allow for improved disbursement and allocation of a load carrying magnetic materials, which enables the assemblies to have a large number of applications with a reduced physical footprint. Distributing the attachment force in the manner disclosed is a significant advancement enabling an apparatus that can be effectively, generally, and safely deployed on all vehicles without restriction. The disclosed assemblies are easily configured for numerous purposes but many other derivative variations utilizing this innovation of distributed magnetism are apparent to provide a specific or general purpose carrier for the transportation of recreation equipment, building materials, merchandise, disposables, or other goods and sundries.

Aspects disclosed herein relate to an apparatus comprising a base, wherein the apparatus further comprises two magnets attached to the base, wherein the magnets are further distributed such that a first magnet is located on a first side of the base and a second magnet is on a second side of the base. In certain embodiments, the magnets are movably affixed to the base such that each magnet can be moved from a position at one of the base toward the middle of base in a groove provided in the base.

In other embodiments, a bar is releasably connected to the base at a first and second end of the base such that the bar can be completely removed from the base. In particular embodiments, the connection of the bar to the apparatus creates a pivot about which the bar can open from an open to a closed position. In more particular embodiments, the apparatus further comprises at least one safety pin and wherein the safety pin prevents the bar from shifting.

In certain embodiments, the apparatus further comprises a cushion attached to the base. In some embodiments, the apparatus further comprises a cushion attached to the bar. In other embodiments, each magnet is affixed to the base by a bolt. In particular embodiments, the bolt is movably disposed within a groove located in the base to allow the bolt to move from a first position to a second position. In certain embodiments, the apparatus further comprises a locking assembly that locks the bar into a closed position.

Additional aspects relate to an adaptive carrier system comprising two or more apparatuses, each comprising a base and two or more distributed, attached magnets; wherein each apparatus supports a portion of a load and wherein each apparatus is operably linked to the other apparatus. In certain embodiments, each apparatus is operably linked to another apparatus by the load positioned on the two or more apparatuses. In particular embodiments, each apparatus is operably linked to another apparatus by one or more linking components. In more particular embodiments, the linking component is affixed to a first apparatus at a first end of the linking component and to a second apparatus at a second end of the linking component. In still other embodiments, the linking component is affixed to the first apparatus by a first removable bolt that is inserted through a first hole in the linking component and a third hole in the apparatus, while the linking component is affixed to the second apparatus by a second removable bolt that is inserted through a second hole in the linking component and a fourth hole in the second apparatus.

In certain embodiments, a bar is releasably connected to the base at a first and second end of the base of each apparatus. In other embodiments, the connection of each bar to each apparatus creates a pivot about which the bar can open from an open to a closed position. In still other embodiments, each apparatus further comprises at least one safety pin and wherein the safety pin maintains the bar in a closed position on the bar. In further embodiments, each apparatus further comprises a cushion attached to the base.

In certain embodiments, each apparatus further comprises a cushion attached to the bar. In other embodiments, each magnet is affixed to the base by a bolt. In particular embodiments, the bolt is movably disposed within a groove located in the base to allow the bolt to move from a first position to a second position. In more particular embodiments, each apparatus further comprises a locking assembly that locks the bar into a closed position. In other embodiments, each apparatus comprises a strap that attaches to a first apparatus at a first end of the strap and further attaches to a second apparatus at a second of the strap.

Other aspects disclosed herein relate to an adaptive carrier comprising two or more adaptive carrier assemblies, each of which consist of an adaptive carrier base, a locking bellcrank asssembly, safety pins, a bar, two magnet assemblies connected to the base by bolts such that the magnets are distributed on the underneath portion of the base.

Further aspects disclosed herein relate to an adaptive carrier comprising two or more adaptive carrier assemblies, each of which consist of an adaptive carrier base, a locking bellcrank assembly, safety pins, a bar, multiple magnet assemblies connected to the base by bolts or other means such that the magnets are distributed on the underneath portion of the base

### BRIEF DESCRIPTION OF THE DRAWINGS

The following figures and descriptions are illustrative embodiments of the disclosed apparatuses and systems:

FIG. 1 is a top view and a side view of a representative embodiment of an adaptive carrier.

FIG. 2 is a top view and a side view of an alternative representative embodiment of an adaptive carrier in a closed position.

FIG. 3 a top view and a side view of an alternative representative embodiment in an open position.

FIG. 4 is a generalized diagram of Safety Strap Assembly of an embodiment of an adaptive carrier.

FIG. 5 is a generalized diagram of a typical deployment of an embodiment of an adaptive carrier.

### DETAILED DESCRIPTION OF THE PREFERRED EMBODIMENTS

This application claims the benefit of priority pursuant to 35 U.S.C. § 119(e) to Provisional Appl. Ser. No. 61/854,829, filed May 3, 2013, the contents of which are incorporated in their entirety.

Disclosed herein are apparatuses and systems for the transportation of equipment and other loads. In particular embodiments, the disclosed apparatus comprises one or more magnet assemblies for securing an apparatus to a car body. The disclosed apparatus also comprises a support in which a load can be placed upon the support. In some embodiments, the support allows for adjustment of the magnet assemblies along the length of the support. In particular embodiments, the apparatus comprises a component such as a bar, clamp assembly or cord to secure the load to the apparatus. The disclosed apparatuses can also be utilized to form a system that can transport a load. In such embodiments, two or more apparatuses are linked to form the load-bearing system. The apparatuses can be linked using the load as the linking component. In other embodiments, a linking component is used to connect two disclosed assemblies. In other embodiments, two linking components link the assemblies. The linking component can be securely affixed to a portion of the assembly by any method known for securing two components. For instance, the linking component can be affixed to each assembly by way of a bolt fitted through a hole in the linking component that aligns with a hole in the assembly.

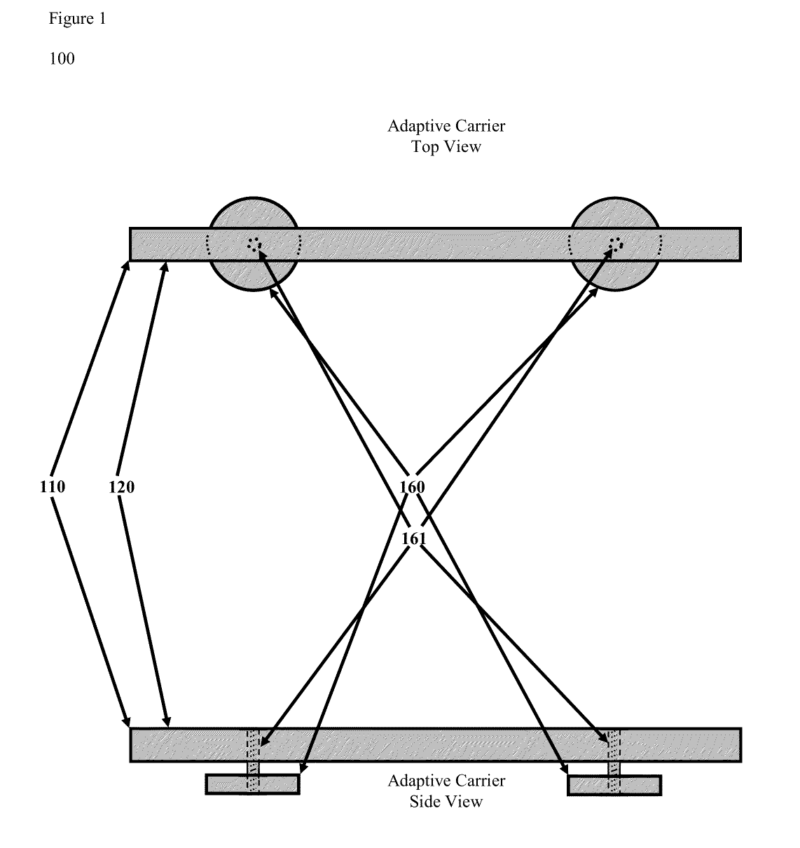

Herein is disclosed a specific embodiment of the disclosed assemblies. Referring to FIG. 1 a representative embodiment of the present invention is illustrated. In FIG. 1 there is shown a front view and a side view of a representative embodiment of the present invention having a composite adaptive carrier assembly 110 consisting of an Adaptive Carrier Base 120, two Distributed Magnet Assemblies 160, and affixing Machine Screws 161. The magnets can be of any type so long as the magnets have a sufficient pull force to attach to the vehicle. In addition, magnet strength is measured by its magnetic field strength and such field strength should be sufficient to withstand highway driving speeds of greater than 60 mph. For instance, magnets of grades N35, N38, N40, N42, N45, N48, N50, N52, 30M, 33M, 35M, 38M, 40M, 42M, 45M, 48M, 50M, or other grades can be used. In addition, magnets having a BHmax of 5 MGOe to 55 MGOe can be used, depending on the size of the magnet. As is known in the art, a larger magnet can be used to increase its magnetic strength. Magnets such as ceramic magnets, neodymium magnets, iron magnets, boron magnets, bonded neodymium iron boron magnets, and aluminum nickel cobalt can be used in the apparatuses disclosed herein. Furthermore, plated magnets can also be used herein. Magnets are commercially available at K & J Magnetics, Inc. (Plumsteadville, Pa.).

Still referring to the alternative representative embodiment of the present invention illustrated in FIG. 1. The Adaptive Carrier Base 120 is a bar, rod, plank, or beam and the Distributed Magnet Assemblies 160 of the Adaptive Carrier 110 are mounted to the Adaptive Carrier Base 120 with Machine Screws 161 enabling the displacement of the Distributed Magnet Assemblies 160 from the Adaptive Carrier Base 120 to be readily adjusted to conform to the roof surface of any host vehicle. In this embodiment the payload is simply laid on the carriers and fixed with machine screws, clamps, cords, or tie-downs. This embodiment supports special purpose sub-carriers as well, functioning as load bars to which sub-carriers can be fixed with machine screws, clamps, cords or tie-donws to the Adaptive Carrier 110 assembly itself. In general practice a pair of Adaptive Carrier Assemblies 110 is used, one in the front portion of the roof of the host vehicle and one in the rear portion of the roof of the host vehicle. However the composite Adaptive Carrier Assemblies 110 are not limited to roof attachment, they can provide the desired transport facility when attached to body, trunk, or hatch surface of any contour as well.

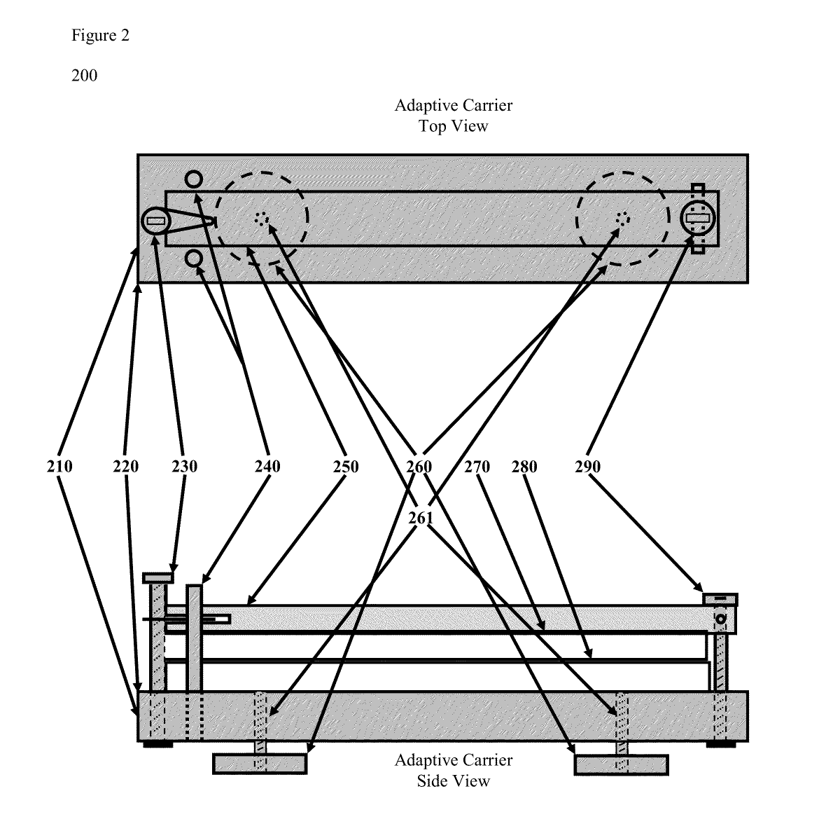

Referring now to FIG. 2 an alternative representative embodiment of the present invention is illustrated. In FIG. 2 there is shown a front view and a side view of a representative embodiment of the present invention having a composite Adaptive Carrier Assembly 210 consisting of an Adaptive Carrier Base 220, a Locking Bellcrank Assembly 230, Safety Pins 240, a Clamping Bar 250, two Distributed Magnet Assemblies 260, affixing Machine Screws 261, an Upper Compression Cushion 270, a Lower Compression Cushion 280, and a Pivot Assembly 290. In general practice a pair of Adaptive Carrier Assemblies 210 is used, one in the front portion of the roof of the host vehicle and one in the rear portion of the roof of the host vehicle. Nevertheless, one or more adaptive carriers can be used. In addition, the composite Adaptive Carrier Assemblies 210 are not limited to roof attachment, they can provide the desired transport facility when attached to body, trunk, or hatch surface of any contour as well.

Still referring to the alternate representative embodiment of the disclosed adaptive carriers is illustrated in FIG. 2, The Distributed Magnet Assemblies 260 of the Adaptive Carrier 210 are mounted to the Adaptive Carrier Base 220 with Machine Screws 261 enabling the displacement of the Distributed Magnet Assemblies 20 from the Adaptive Carrier Base 220 to be readily adjusted to conform to the roof surface of any host vehicle.

Still referring to the alternative representative embodiment of the disclosed adaptive carriers is illustrated in FIG. 2, the payload of the Adaptive Carrier 210 is placed on the Lower Compression Cushion 280 and held in place by rotating the Clamping Bar 250 and Upper Compression Cushion 270 (which is affixed to the Clamping Bar 250 with adhesive or other means) to the to the lowest position. The Clamping Bar 250 is locked in place by rotating the Locking Bellcrank Assembly 230 into the locked position. The Safety Pins 240 prevent the Clamping Assembly 250 from shifting.

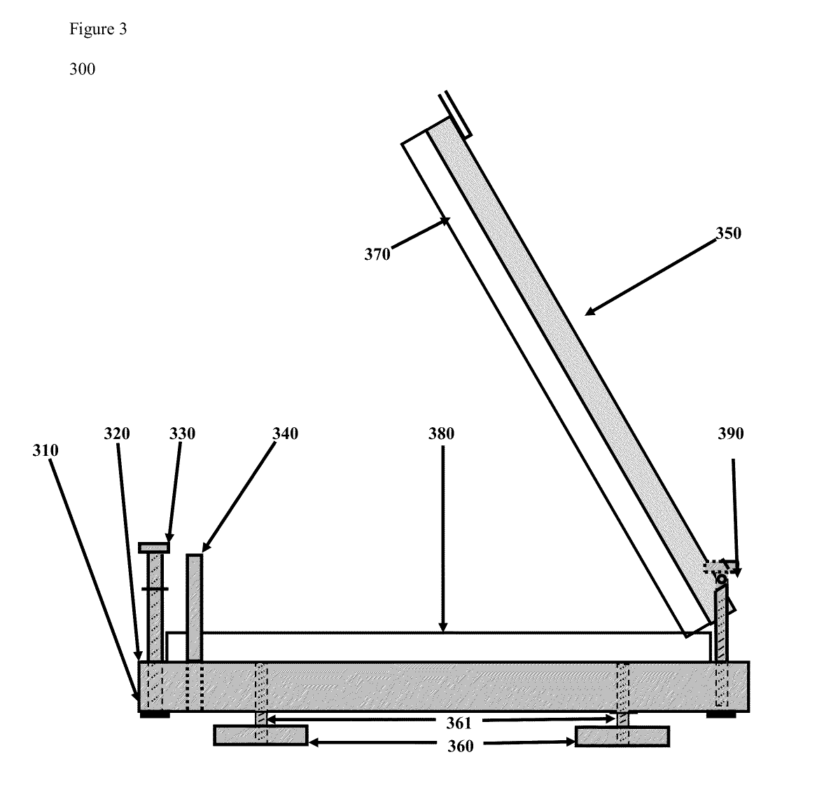

Referring now to FIG. 3 a side view of a representative embodiment is illustrated. In this view the Locking Bellcrank Assembly 330 composite Adaptive Carrier Assembly 310 has been rotated to the open position and the Clamping Bar 350 and Upper Compression Cushion 370 has been raised by rotating the Clamping Bar 350 about the Pivot Assembly 390. The Locking Bellcrank Assembly 330 screws into the Adaptive Carrier Base 320 enabling the clamping force to be adjustable. Safety Pins 340 are permanently attached to Adaptive Carrier Base 320 to prevent rotation of the Clamping Bar 350 and Upper Compression Cushion 370 when in the closed position. Upper Compression Cushion 370 and Lower Compression Cushion 380 provide scratch protection and slip resistance for the payload. In this configuration skis, poles, or other payload can be readily placed for carriage. Pivot Assembly 390 enables the Clamping Bar 350 and Upper Compression Cushion 370 to be freely opened and rotated while loading and unloading the payload. The Distributed Magnet Assemblies 360 provide the primary holding force for the payload and affixed to the Adaptive Carrier Base 320 with Machine Screws 361. The vertical distance of Distributed Magnet Assemblies 360 from the Adaptive Carrier Base 320 can be simply adjusted by rotating the

Distributed Magnet Assemblies 360, which are permanently affixed to the Machine Screws 361 enabling the displacement of the Distributed Magnet Assemblies 360 from the Adaptive Carrier Base 320 to be readily adjusted to conform to the roof surface of any host vehicle

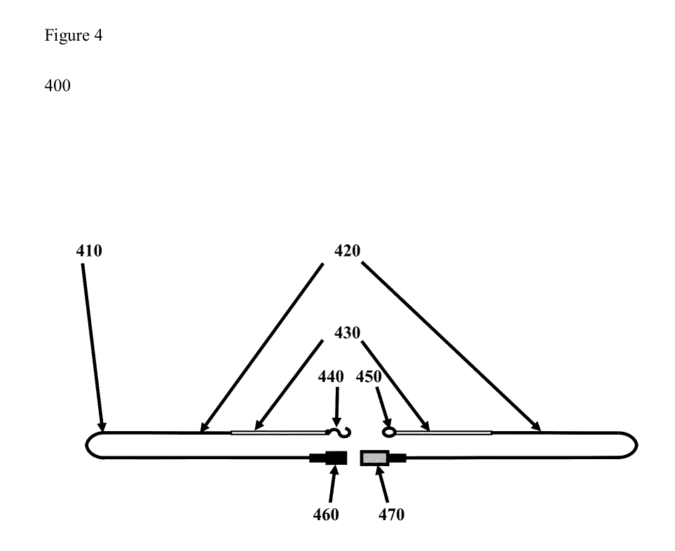

Referring now to FIG. 4 a view of the Safety Strap Assembly 410 of an alternative representative embodiment of the disclosed adaptive carriers is illustrated. In this deployment the Safety Strap Assembly 410 is wrapped through the doors of the host vehicle and across the top of the payload of the Adaptive Carrier. Inelastic Strap Components 420 are stitched to Elastic Strap Components 430. Adjustable Male Connector 460 and Adjustable Female Connector 470 are manipulated to vary the effective length of the Safety Strap Assembly 410 to accommodate the width of the host vehicle. Adjustable Male Connector 460 is then plugged into Adjustable Female Connector 470. S Hook Connector 440 and Eye Connector 450 are pulled toward one another stretching Elastic Strap Components 430. S Hook Connector 440 is threaded into Eye Connector 450 securing the payload.

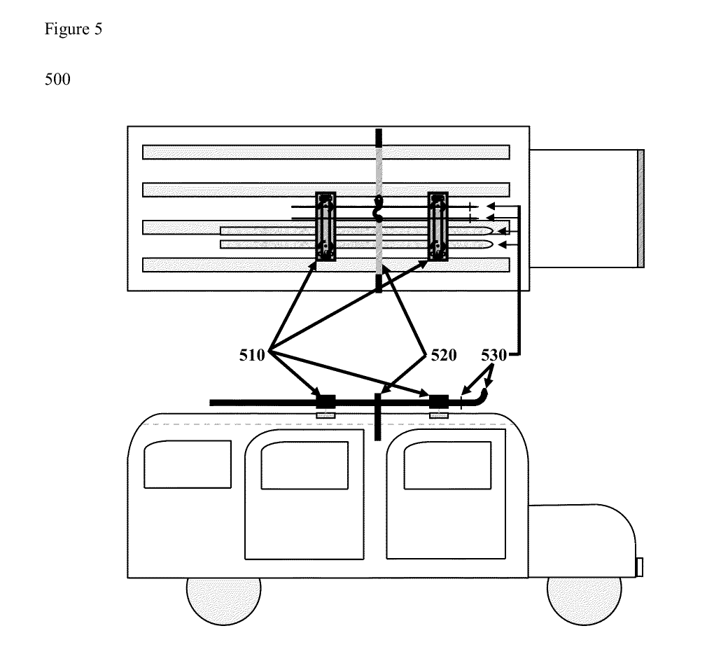

Referring now to FIG. 5 a generalized top view and side view diagram of a typical deployment of the present invention. A payload of a pair of skis and a pair of ski poles 530 is depicted loaded and secured to the host vehicle with a pair of adaptive carrier assemblies 520 and Safety Strap Assembly 520. The deployment of the adaptive carrier assemblies 520 is not limited to the roof of a host vehicle the innovative adaptive design enables deployment on any interior or exterior ferrous surfaces of the host vehicle including roof, trunk, hatch, front, back, and side surfaces of any contour.

The construction details of the present invention are that the materials for the Adaptive Carrier Assembly 110 in a representative embodiment of the invention shown in FIG. 1 and the adaptive carrier assembly 210 in the alternative embodiment of the present invention shown in FIG. 2, and the adaptive carrier assembly 310 in the alternative embodiment of the present invention shown in FIG. 3 and for any alternative embodiment are standard materials including, but not limited to, aluminum, steel, wood, plastics including thermoplastics, and composite materials such as alloys, carbon-reinforced plastic, and glass-reinforced plastic. In particular embodiments, the adaptive carrier assembly can be provided as individual components or particular components can be provided as an integrated cluster. Construction of components and assemblies may be accomplished by hand or automated assembly process known in the art. In particular, the fabrication and interconnection of the Adaptive Carrier can be made via extrusion, shaping, welding, gluing, screws, nuts and bolts, or other fasteners.

The size, shape, and pattern of an embodiment of the Adaptive Carrier Assembly 110 is shown in FIG. 1 and the Adaptive Carrier Assembly 210 in an alternative embodiment is shown in FIG. 2, and the Adaptive Carrier Assembly 310 is an alternative embodiment in FIG. 3. It should be noted that the size and shape of the magnets, base, and other components can be altered without departing from the invention.

Although particular embodiments of the disclosed apparatuses have been shown, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

The disclosed apparatuses and systems disclosed herein allow for secure transportation of a payload such as recreational equipment including skis, snowboards, and bikes, on all ferrous roofs, smooth or grooved with or without sun roofs and on all other vehicle ferrous surfaces such as doors, trunks, and hatches. Additionally, the disclosed roof rack assemblies have a reduced profile compared to commercially available roof racks, significantly improving appearance, increasing fuel economy, and safety. The disclosed assemblies further allow for improved disbursement and allocation of a load carrying magnetic materials, which enables the assemblies to have a large number of applications with a reduced physical footprint. Distributing the attachment force in the manner disclosed is a significant advancement enabling an apparatus that can be effectively, generally, and safely deployed on all vehicles without restriction.

The disclosed assemblies are easily configured for numerous purposes but many other derivative variations utilizing this innovation of distributed magnetism are apparent to provide a specific or general purpose carrier for the transportation of recreation equipment, building materials, merchandise, disposables, or other goods and sundries. The distribution of the magnetic force material about the carrier enables the disclosed apparatuses to be effective on all ferrous material interior or exterior surfaces of any vehicle. This includes roof, trunk, hatch, sides, and front and back and side ferrous surfaces of any contour of any host vehicle.

1. An apparatus comprising a base, wherein the apparatus further comprises two or more magnets attached to the base, wherein the magnets are distributed along the base.

2. The apparatus of claim 1, wherein the magnets are movably affixed to the base such that each magnet can be moved to any position along the base in a groove provided in the base or to any one of multiple threaded mounting holes configured along the bar.

3. The apparatus of claim 1, wherein a bar is releasably connected to the base at a first and second end of the base such that the bar can be completely removed from the base.

4. The apparatus of claim 1, wherein the connection of the bar to the apparatus creates a pivot about which the bar can open from an open to a closed position.

5. The apparatus of claim 1, wherein the apparatus further comprises at least one safety pin and wherein the safety pin prevents the bar from shifting.

6. The apparatus of claim 1, wherein each magnet is affixed to the base by a bolt.

7. The apparatus of claim 8, wherein each bolt is movably disposed within a groove located in the base to allow the bolt to move from a first position to an alternative position or each bolt is movably disposed to any one of multiple threaded mounting holes configured along the bar to allow the bolt to move from a first position to an alternative position.

8. The apparatus of claim 1, wherein the apparatus further comprises a locking assembly that locks the bar into a closed position.

9. An adaptive carrier system comprising two or more apparatuses, each comprising a base and two or more distributed, attached magnets; wherein each apparatus supports a portion of a load and wherein each apparatus is operably linked to the other apparatus.

10. The adaptive carrier system of claim 11, wherein each apparatus is operably linked to another apparatus by the load positioned on the two or more apparatuses

11. The adaptive carrier system of claim 11, wherein each apparatus is operably linked to another apparatus by one or more linking components.

12. The adaptive carrier system of claim 13, wherein the linking component is affixed to a first apparatus at a first end of the linking component and to a second apparatus at a second end of the linking component.

13. The adaptive carrier system of claim 14, wherein the linking component is affixed to the first apparatus by a first removable bolt that is inserted through a first hole in the linking component and a third hole in the apparatus, while the linking component is affixed to the second apparatus by a second removable bolt that is inserted through a second hole in the linking component and a fourth hole in the second apparatus.

14. The adaptive carrier system of claim 11, wherein a bar is releasably connected to the base at a first and second end of the base of each apparatus.

15. The adaptive carrier system of claim 11, wherein the connection of each bar to each apparatus creates a pivot about which the bar can open from an open to a closed position.

16. The adaptive carrier system of claim 11, wherein each apparatus further comprises at least one safety pin and wherein the safety pin maintains the bar in a closed position on the bar.

17. The adaptive carrier system of claim 11, wherein each magnet is affixed to the base by a bolt.

18. The adaptive carrier system of claim 21, wherein the bolt is movably disposed within a groove located in the base to allow the bolt to move from a first position to a second position.

19. The adaptive carrier system of claim 11, wherein each apparatus further comprises a locking assembly that locks the bar into a closed position.

20. The adaptive carrier system of claim 11, wherein each apparatus comprises a strap that attaches to a first apparatus at a first end of the strap and further attaches to a second apparatus at a second of the strap.
